(19) United States
(12) Patent Application Publication
(10) Pub. No.: US 2013/0066796 A1
(43) Pub. Date: Mar. 14, 2013

(54) SYSTEM AND METHOD FOR PROVIDING VISUAL JOB INFORMATION AND JOB SEEKER'S INFORMATION

(71) Applicant: Roger John Stanton, Geneva, IL (US)

(72) Inventors: Young Jea Shin, Plainfield, IL (US); Roger John Stanton, Geneva, IL (US)

(21) Appl. No.: 13/551,404

(22) Filed: Jul. 17, 2012

Related U.S. Application Data
(63) Continuation-in-part of application No. 13/071,610, filed on Mar. 25, 2011.
(60) Provisional application No. 61/317,354, filed on Mar. 25, 2010.

(51) Int. Cl. G06Q 10/06

(52) U.S. Cl. 705/321

(57) ABSTRACT

A multimedia recruitment system for providing job information and/or job seeker's information in a visual or video format is described. The multimedia recruitment system may deliver job and career opportunity information in a high quality visual or video representation. The multimedia recruitment system may also provide job seeker or job candidate's information in a visual or video representation. The visual or video representation may be provided through TV channels or networks, on-line communication networks, wireless networks, etc.

### RELATED APPLICATION

This application claims priority to, and the benefit of, U.S. Provisional Application Ser. No. 61/317,354, filed Mar. 25, 2010, for all subject matter common to both applications, and claims priority to, and the benefit of, U.S. non-provisional application Ser. No. 13/071,610, filed Mar. 25, 2011. The disclosure of said provisional application and non-provisional application is hereby incorporated by reference in its entirety. This application is a continuation-in-part of U.S. patent application Ser. No. 13/071,610, filed Mar. 25, 2011, also entitled System and Method for Providing Visual Job Information and Job Seeker's Information, naming Young Jea Shin as the inventor, all of which are incorporated herein by reference.

### FIELD OF THE INVENTION

The present disclosure relates to an automated process and associated computerized system for improving the recruitment process of qualified candidates for opened positions of different job postings, the process and system includes a platform for transforming information into a video posting displaying human and written video highlights based on the information, and more particularly to an online platform for uploading a text job opening and receiving a encoded video to imbed in internet sites where job seekers can access the posting.

### BACKGROUND OF THE INVENTION

The present application relates to a system and method for providing job information to job seekers in a visual or video format and/or job seekers' information to employers in a visual or video format.

In the conventional recruitment systems, employers post job information on the job board in a text-based format. The job seekers who apply for the job submit their resume and other information in a text-based format.

Many corporations have an ongoing flow of job openings to be filled by candidates and require an automated and simplified process for managing these job openings. Further, these corporations desire to reach a wider audience of potential job seekers and receive a larger proportion of well qualified and highly motivated applicants.

As each job opening differs and the unique and necessary qualifications for each posting differ, it may be difficult for potential applicants to distinguish certain requirements that are essential to the opening from other requirements that are used to give a profile of what may be a good applicant.

In the pre-internet era, employers used newspapers ads to post new openings. A human resource manager would make an executive decision as to the publication in different newspapers, covering different geographical areas, and this manager would also decide the size of the posting and the font size for each requirement. Job seekers by looking at the ad and the newspaper reputation would get some type of information as to which requirement will be strictly observed, and which will generally be useful to get a position. Other types of venues for job postings included small job related publications, and local television channels offering wanted ad services. In each case the distribution of the job offer was limited in its potential to reach qualified candidates and distinguish between the essential job requirements from secondary job requirements.

Today with the arrival of the internet and other types of online or wireless communications, job seekers are bombarded with text-based job descriptions. In this fluid format of information, it may be very difficult to distinguish between essential job requirements and secondary job requirements, it is also difficult to distinguish between important ads posted by employers and less important ads as these may be posted side by side on a board or list.

What is needed is a new and cost efficient system and process for facilitating the transfer of information between potential employers and job seekers and increasing the number of qualified applicants for any given job opening.

### BRIEF SUMMARY OF THE INVENTION

An exemplary embodiment of the present application is a multimedia recruitment system for delivering job and career opportunity information in a visual or video format to potential job seekers. The exemplary embodiment automatically converts text-based job descriptions provided by employers and/or recruiters relating job openings, into a high quality visual or video representations (“Job Reports”).

The Job Reports are then distributed to job seekers through a plurality of media including for example television (“TV”) channels or networks, on-line communication networks, wireless networks, etc. The exemplary embodiment provides a new recruitment system that brings the power of video and the convergence of media to the employers as well as to the job seekers.

An exemplary embodiment may provide job seekers or job candidates' information in a visual or video format. Unlike the conventional text-based resume, the exemplary embodiment may generate visual or video representations (“Video Introductions”) of the job seekers or job candidates' information. The exemplary embodiment may enable the job seekers or job candidates to submit their Video Introductions to employers through TV channels or networks, on-line communication networks, wireless networks, etc. The employers can reduce a screening process using the Video Introduction.

### BRIEF DESCRIPTION OF THE DRAWINGS

FIG. 1 is a screen shot of a frame from a Job Report in an exemplary embodiment;

FIG. 2 is a screen shot of an exemplary contact information page displayed at the end of the exemplary Job Report as shown at FIG. 1;

FIG. 3 is a screen shot of a different frame from the Job Report shown at FIG. 1 in which an on-air talent interviews a company executive or a recruiter to deliver job information and/or company information;

FIG. 4 is a flow chart showing the interactions between an employer and a multimedia recruitment system used as part of the recruitment system to generate the Job Report shown at FIG. 1 in an exemplary embodiment;

FIG. 5 is a diagram showing how the a script and the graphic form are input to a teleprompter and a character generator as part of the multimedia recruitment system;

FIG. 6 is a diagram of portions of the multimedia recruitment system shown at FIG. 4 used to generate a Job Report as shown at FIG. 1 in an exemplary embodiment;

FIG. 7 is a diagram showing the distribution of the Job Report of FIG. 1 to TV channels in an exemplary embodiment;

FIG. 8 is a diagram showing the distribution of the Job Report of FIG. 1 in a Job Video .FLV format and ultimately posted on an exemplary website in an exemplary embodiment;

FIG. 9 is a diagram showing the distribution of the Job Report of FIG. 1 is posted on a mobile friendly website in an exemplary embodiment;

FIG. 10A is a flow chart showing production of a Video Introduction in an exemplary embodiment;

FIG. 10B is a block diagram showing the server side application and the client side application running on the multimedia recruitment system and the job seeker's device, respectively, in an exemplary embodiment;

FIG. 10C shows an interaction between the server side application and the client side application during the production of a Video Introduction in an exemplary embodiment;

FIGS. 10D-10F are screen shots of the user interfaces provided by the client side application running on the job seeker's device in an exemplary embodiment;

FIG. 11 is an exemplary network environment suitable for implementing a recruitment system for generating a Job Report as shown at FIG. 1 ; and

FIG. 12 depicts a computing device suitable for practicing the recruitment system for generating a Job Report in a network environment.

### DETAILED DESCRIPTION OF THE INVENTION

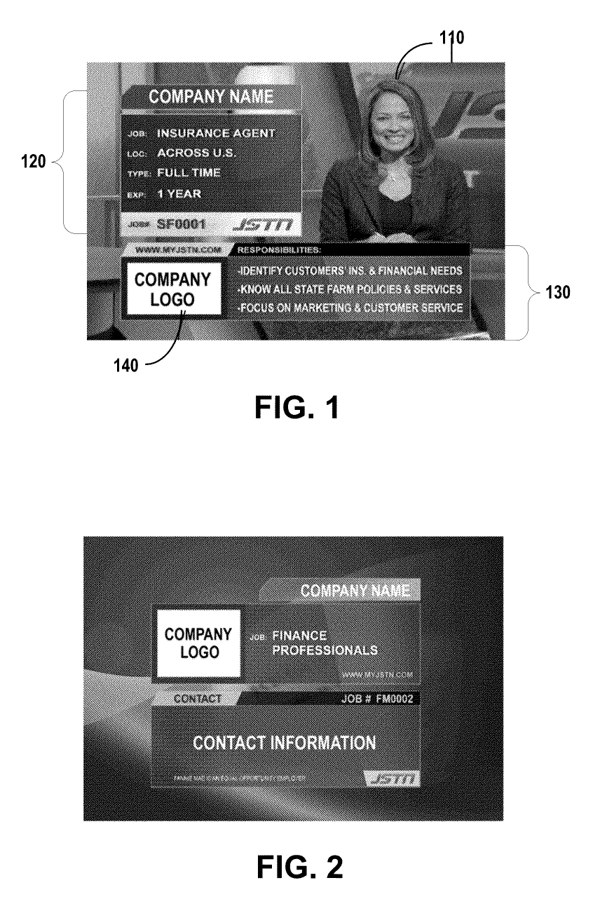

As shown at FIGS. 1-12, this invention relates to a multimedia recruitment system for providing and transforming job related information in a visual or video format and for generating a visual or video representation of this information in what is referred to as a Job Report. A text-based job description is received from an employer and/or a recruiter and in turn this description is used to generate a visual or video representation of associated with the job description.

The invention provides a multimedia recruitment system for providing to a job seeker or a job candidate information in a visual or video format relating to a job opening. In addition, the multimedia recruitment system also provides to the job seeker or the job candidate a tool for generating a visual or video representation of the job seeker or job candidate's information back as a response to the Job Report. The visual or video representation of the job seeker or the job candidate with personal information sufficient to answer the job opening is referred to as a Video Introduction.

The visual or video format or representation may include at least a series of image or picture frames for a predetermined time period or duration. The visual or video representation may be provided in a wide range of video formats, which use different COmpressors-DECcompressorS (CODECS) to encode and compress video data. The possible contemplated video formats include, but are not limited to, .3GP (3GPP Multimedia File), .FLV (Flash Video File), .MPG (MPEG Video File), .WMV (Windows Media Video File). The visual or video representation may also include an audio stream of data.

Description of the Job Report

FIG. 1 is a screen shot of one of the frames of an exemplary Job Report. The invention generates for example a Job Report that is specific and customized to an individual job opening. The Job Report may have a predetermined fixed length of time or a variable length of time depending on the job description provided by an employer. For example, the Job Report may be 30 seconds in length. In the Job Report, the job description may be as shown partly delivered by an on-air talent 110 in a network news style. While one type of delivery is shown, one of ordinary skill in the art will appreciate that other types of delivery styles aside from the network news style may be used.

The on-air talent 110 may first introduce a job listing while relevant position information is displayed as shown at 120, 130 on the side and/or bottom of the screen as shown. . The Job Report may contain the employer or company's logo 140 and key statistics about the company and the job positions available. In the background, as shown, the logo of a third party offering services associated with the production of Job Reports (i.e. JSTN) may be displayed in the back, on the relevant positions 120, 130.

The Job Report as shown at FIG. 1 may include several graphic areas 120 and 130 displayed at different portions of the screen. In the example shown at FIG. 1, one of the two graphic areas is located on left side of the screen, and the second graphic area is located on the bottom of the screen. The first graphic area 120 may be provided at the left upper corner of the screen. The graphic area may display information such as an employer's name, a job title for the position, a job location for the position, a job type, a required experience/education level and a unique job number.

The second graphic area 130 as shown may be provided at the bottom area of the screen. In the second graphic area 130, different information may be displayed in sequence or even scrolled as for stock or live news tickers. For example, an employer information may be displayed next to other important information 130. This information may include benefit information , the responsibilities of the position, and then the qualifications of the position. This area 130 may include a single or a plurality of lines for the display the this information. As shown, the second graphic includes three lines each with up to 45 characters. The employer's logo 140 may be displayed in the second graphic area. While one possible configuration of information display is shown, what is contemplated is the use of any known techniques to display as an overlay over an anchor the information.

FIG. 2 illustrates a screen shot of a job and contact information page generally reserved for the end portion of the Job Report. On FIG. 2, at the top of the screen, an employer name, an employer's logo and a job title is be displayed. At the bottom of the screen, the employer's contact information, a job identification number and a disclaimer is displayed. Once again, as shown the logo of a third party service provider may be imbedded within these images to help give every Job Report describing jobs from a large number of different potential employers an overall look and feel. While one possible display of information is shown, what is contemplated is the display of information in any number of configurations.

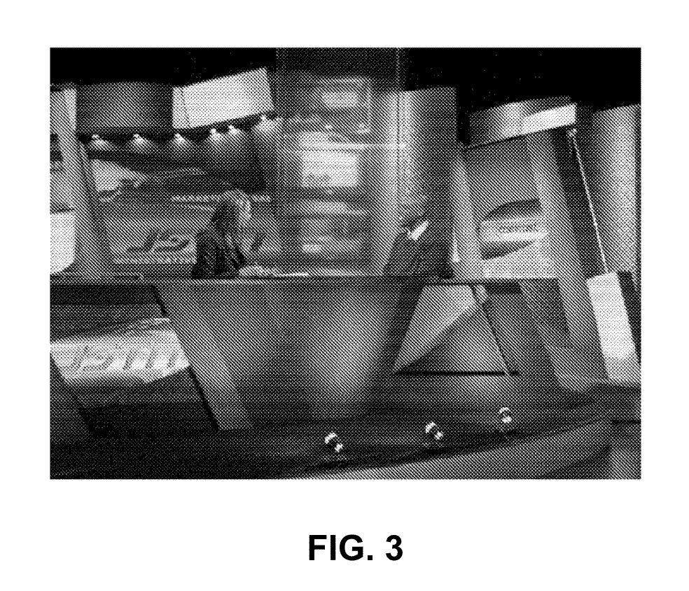

FIG. 3 shows a screen shot of an exemplary Job Report from a different camera angle in which an on-air talent 110 interviews a company executive or a recruiter to help deliver some of the company information. During the interview, the company logo may be displayed on the background of the Job Report or it may be placed in different areas around the display area. While FIG. 3 shows one possible different camera angle or method of display of the information using external actors or other sources of information, what is contemplated is the use of any incrustation of video, or information in any format known in the news industry. In addition to inputting the graphic form into the character generator, the second video includes information selected from a group consisting of a film of an external actor, incrustation of a video, information from the news industry.

The Production of a Job Report

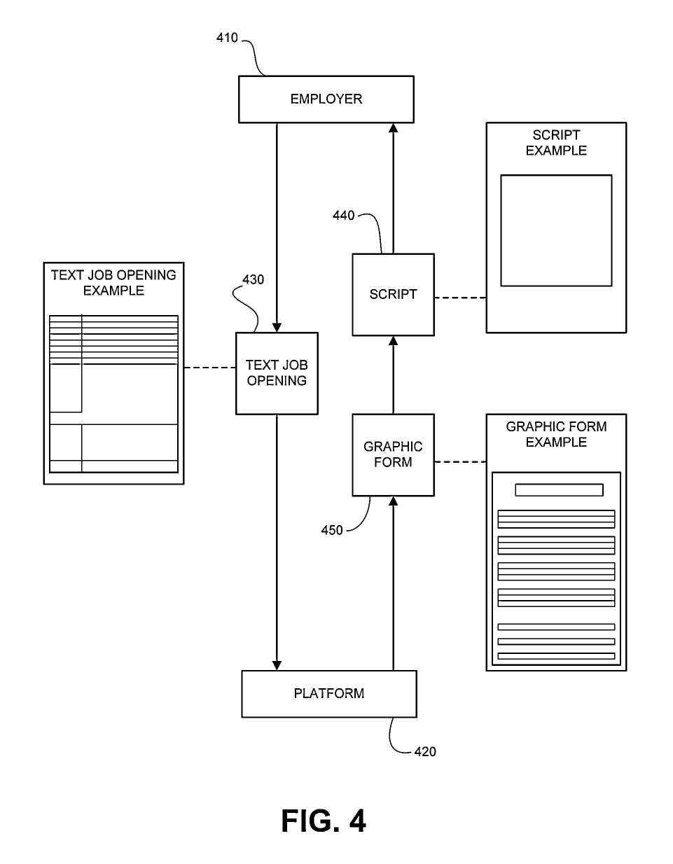

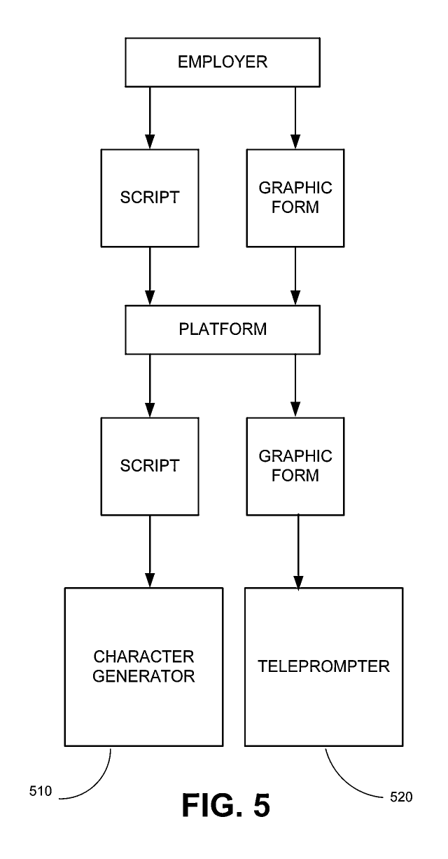

FIG. 4 is a flow chart showing the interactions between an employer 410 who must fill a job vacancy and the multimedia recruitment system shown here as a platform 420 to produce a Job Report as shown at FIG. 1. An employer provides a text-based job description 430, an in an alternate embodiment, the employer the employer uploads the text-based job description 430 using a pre-populated form in a text editor format and more precisely using an online web form. The multimedia recruitment system 420 can also generate a script 440 for the on-air talent 110 to read outloud using a teleprompter 520 as shown at FIG. 5 and to be incorporated as part of the Job Report shown at FIG. 1. The script 440 is then sent in some embodiments back to the employer 410 for approval (as illustrated by the arrow). As illustrated at FIG. 4 in a page drawn with the label ‘script example,’ the script 440 is text to be read outloud by one or several actors as part of the Job Report.

At the same time, the multimedia recruitment system 420 may generate and send graphic forms 450 directly for processing as shown at FIG. 5 or for the employer 410 to fill out. The graphic forms 450 are text to be displayed on the screen of the Job Report as discussed above with reference to FIG. 1. After the employer 410 approves the script 440 and alternatively also fills out the graphic form 450 if one is generated, the employer 410 returns the script 440 and the graphic form 450 to the multimedia recruitment system. These exchanges of information between the employer 410 and the platform 420 also the recruitment system for generating a Job Report are designed to be optimized and minimized in size and volume. Employers 410 often look for many closely related candidates and the different scripts 440 and graphic forms 450 will be closely related as the text job opening 430 will also be extremely similar (e.g. two engineers may have only the level of experience different). By using forms and validation steps as part of this process, the employer 410 and the platform 420 can be programmed to generate the different intermediate documents 430, 440 and 450 in less time and effort.

FIG. 5 is a diagram showing how the script 440 from FIG. 4 is input to the teleprompter 520 to be read out-loud by the talent 110 as shown at FIG. 1. The graphic forms 450 are in turn input to a character generator 510 in the multimedia recruitment system as shown at FIG. 4. The multimedia recruitment system 420 may include the character generator 510 and the teleprompter 520. FIG. 5 shows how once the employer 420 has approved both the script 440 and the graphic form 450, the employer 410 can provide the script 440 and the graphic form 450 to the platform 420 also described as the multimedia recruitment system and both of these documents are in turn sent to two elements 510 and 520 that can also be considered part of the platform 420 that are useful external tools to generate the Job Report. In an alternate embodiment, the character generator and the teleprompter 510, 520 are internal to the multimedia recruitment system but external to the platform 420.

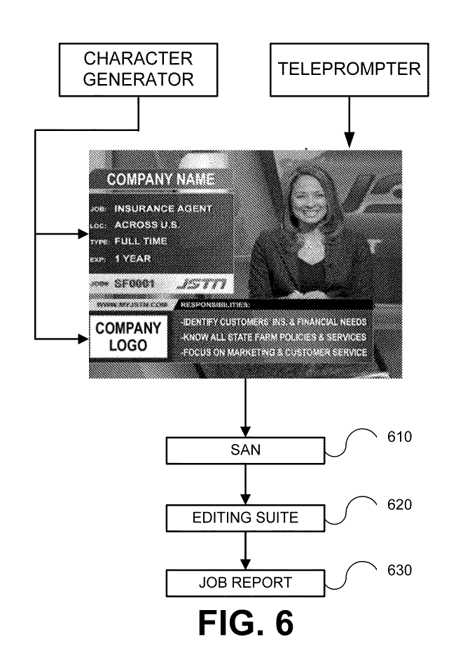

FIG. 6 is a diagram of an exemplary multimedia recruitment system that generates a Job Report with a third portion of the entire process illustrated in full by FIGS. 4-6. . When the multimedia recruitment system 420 produces a Job Report, the multimedia recruitment system feeds the graphic information from the character generator and the script to a teleprompter while taping. The Job Report with graphic areas and the Job Report without graphic areas are recorded in the video tape recorders as well as captured in the Quicktime video format, which is known as .MOV file. The .MOV files are stored in the Storage Area Network (SAN) 610. The video clips with graphic areas are edited in the editing system 620 to produce a predetermined length of a Job Report 630.

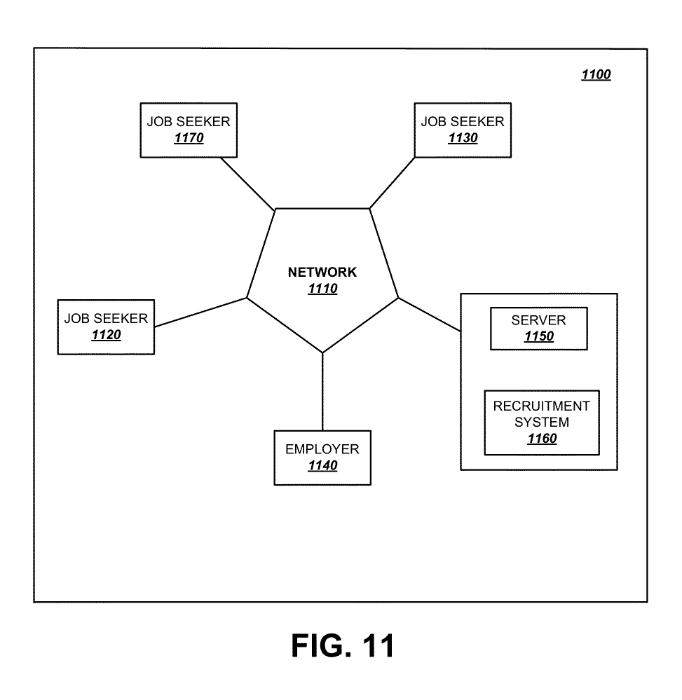

What is described is a recruitment system 420 for generating a Job Report as shown in FIG. 1 in a network environment as described in FIG. 11. The recruitment system 420 includes a server 1150 as shown at FIG. 11 to house the recruitment system 420 coupled as shown to a plurality of job seeker devices 1120, 1130, and 1170 and at least an employer device 1140 via a communication network 1110.

In the system 420, an employer 410 uploads using the employer device 1140 a text-based job description 430 relating to a job opening to the server 1150 via the communication network link 1110 between the employer device and the server (shown by lines between the units). The server 1150 includes a multimedia requirement system 1160 also shown as 1200 for the production of a Job Report produced by transforming the text-based job description 430 using a platform 420 into a script 440 and a graphic form 450 by inputting the script 440 into a teleprompter 520 to be read by an on air talent 110 and recorded using a camera (not shown) as a first video. Further, the system 420 produces the Job Report as shown at FIG. 1 by inputting the graphic form 450 into a character generator 510 for producing a second video and by storing the first and second videos in a storage area network 610 as shown at FIG. 6.

Finally, the system 420 also allows for editing the first and second videos using an editing suite 620 to produce with both the first and second videos the Job Report as shown at FIG. 1. The Job Report as shown at FIG. 11 can be viewed by at least a job seeker using one of the plurality of job seeker devices 1120, 1130, and 1170 over the communication network 1110 from the server 1150.

In another embodiment, Job Report is uploaded by the employer 410 using the employer device 1140 from the server 1150 and the Job Report is viewed on a employer website instead of the server 1150 after being uploaded in a video format and merged into an HTML web page.

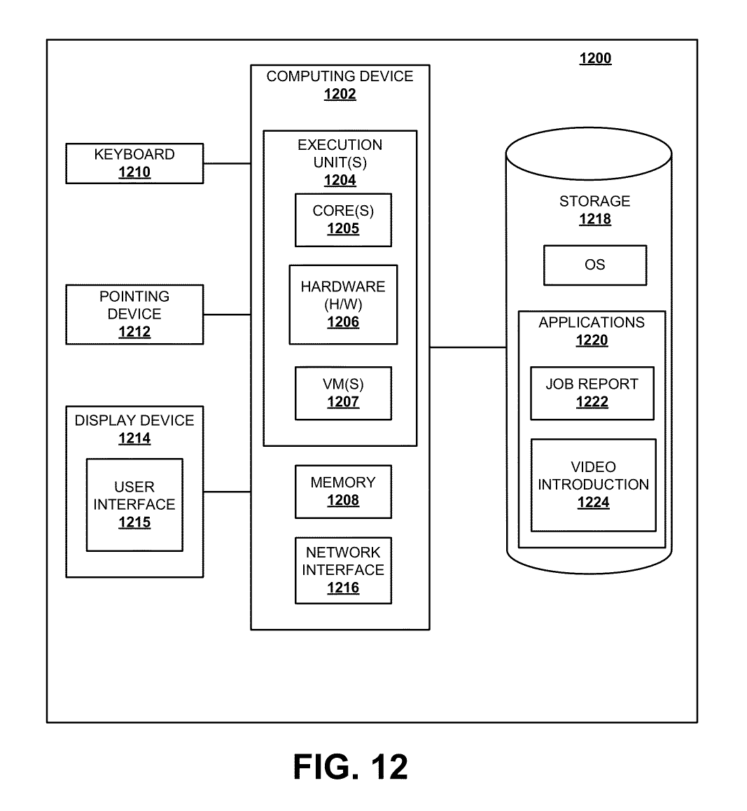

What is also contemplated and described is a method for producing a Job Report as shown at FIG. 1. The method is performed by conducting using the hardware as described above the steps of (a) uploading a text-based job description 430 relating to a job opening in a multimedia requirement system 420 using an employer device 1140 connected to a server 1150 hosting the multimedia requirement system 1160. The multimedia requirement system 1160 as shown at FIG. 12 can be located in a computing device 1202 with an execution unit 1204, a memory 1208, and a network interface 1216 in communication with a storage 1218.

The next step is to transform the text-based job description 430 using the platform 420 into a script 440 and a graphic form 450, and then inputting the script 440 into a teleprompter 520 to be read by an on air talent 110 and recorded using a camera (not shown) as a first video. The next step is the input of the graphic form 450 into a character generator 510 for producing a second video, and finally storing the first and second videos in the storage 610 and editing the first and second videos 620 to produce a Job Report.

Other possible steps include having at least one of a plurality of job seekers through their own devices uploading the Job Report on a job seeker device 1120, 1130, and 1170 connected to the multimedia requirement system 420. The Job Report can also be viewed using a video streamer from a web-based interface, and using a review step as part of this method.

Distribution of Job Report

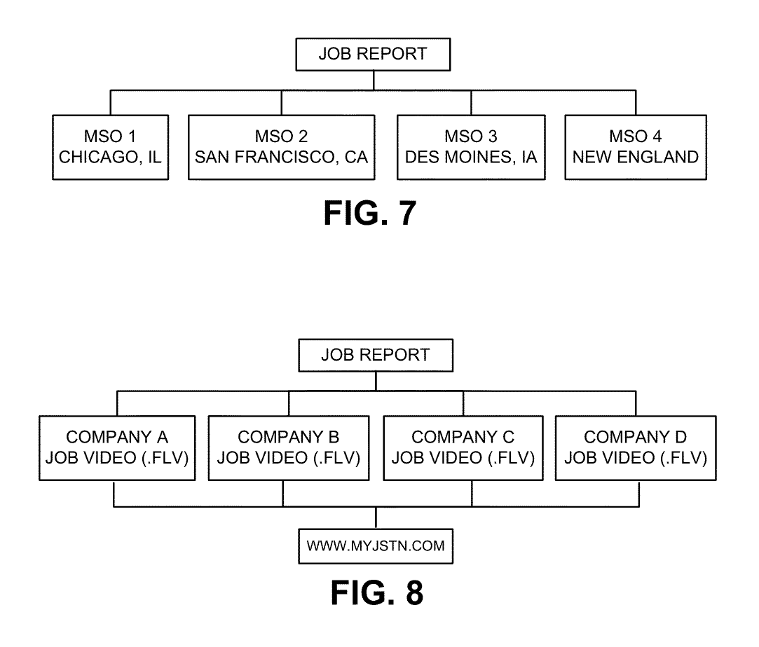

FIG. 7 is a diagram showing how the Job Report is distributed to those who broadcast the Job Reports via TV channels or networks. Once the Job Report is produced, the multimedia recruitment system prints out the Job Report on the video tapes and distributes the video tapes to dedicated market MSOs (Multiple System Operators), such as Comcast, Time Warner, Cox and Mediacom, etc. The Job Reports are broadcasted via the TV channels or networks. In an embodiment, the Job Report may be distributed using a satellite or an optical fiber.

FIG. 8 is a diagram showing that the Job Report is posted on a website in an exemplary embodiment. The multimedia recruitment system may transfer each Job Report into a Flash Video File, which is known as .flv files, and send the .flv files to the website to post the Job Report on the website.

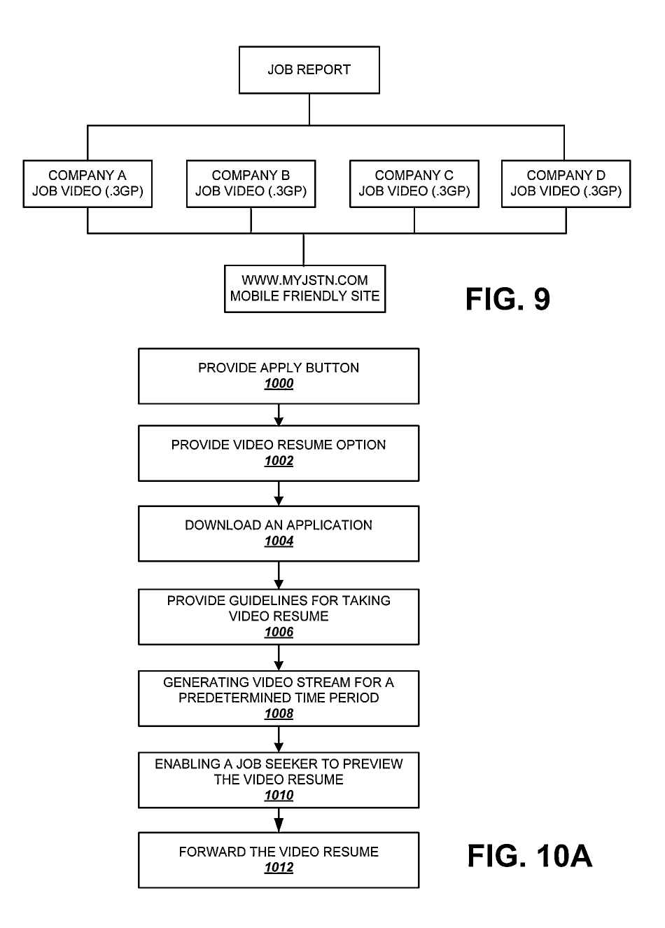

FIG. 9 is a diagram showing that the Job Report is posted on a mobile friendly website in an exemplary embodiment. The multimedia recruitment system may transfer each Job Report into mobile phone video file, which is known as .3gp, to post the Job Report on a mobile friendly site. The Job Report can be viewed on the mobile phone, which can access the mobile friendly site.

Video Introduction Production

To create a Video Introduction, the job seeker's device, such as a TV set, a computer and a mobile device, may include a camera to generate a video data stream in the job seeker's device.

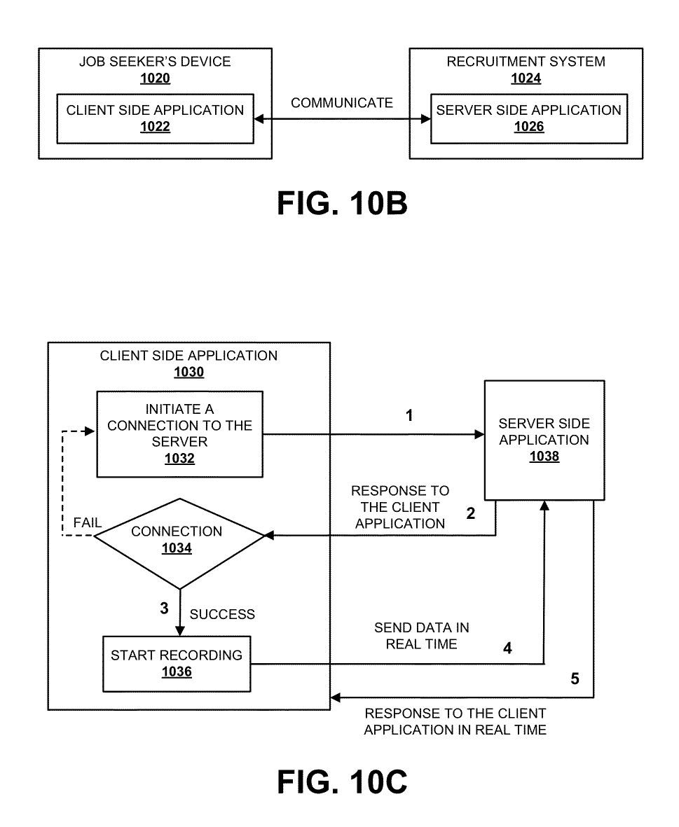

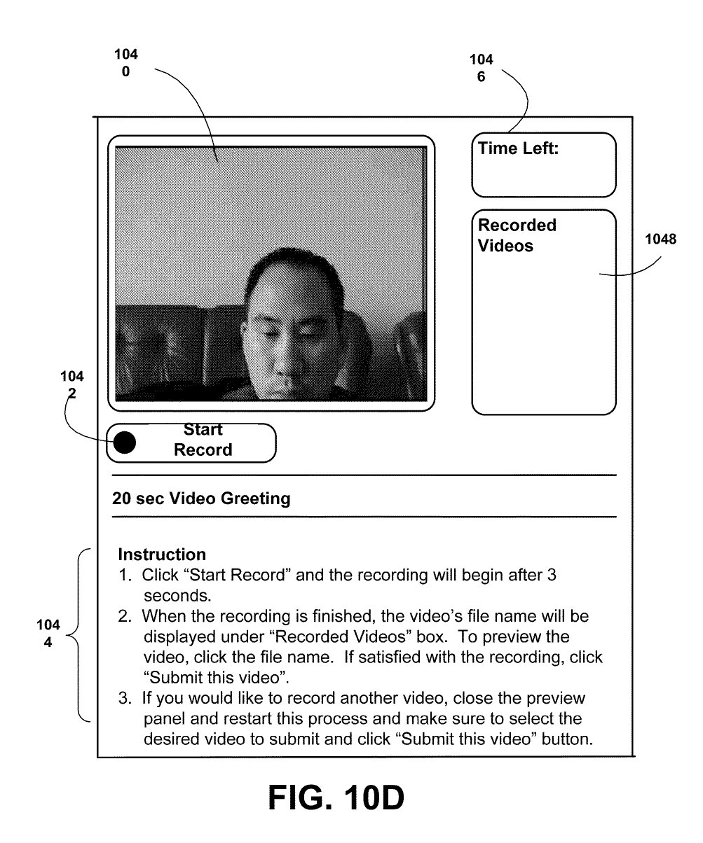

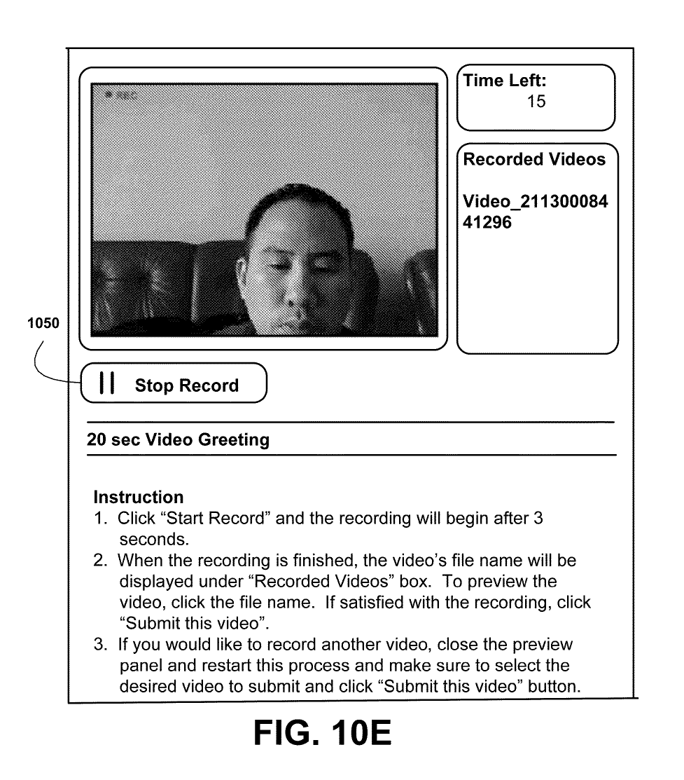

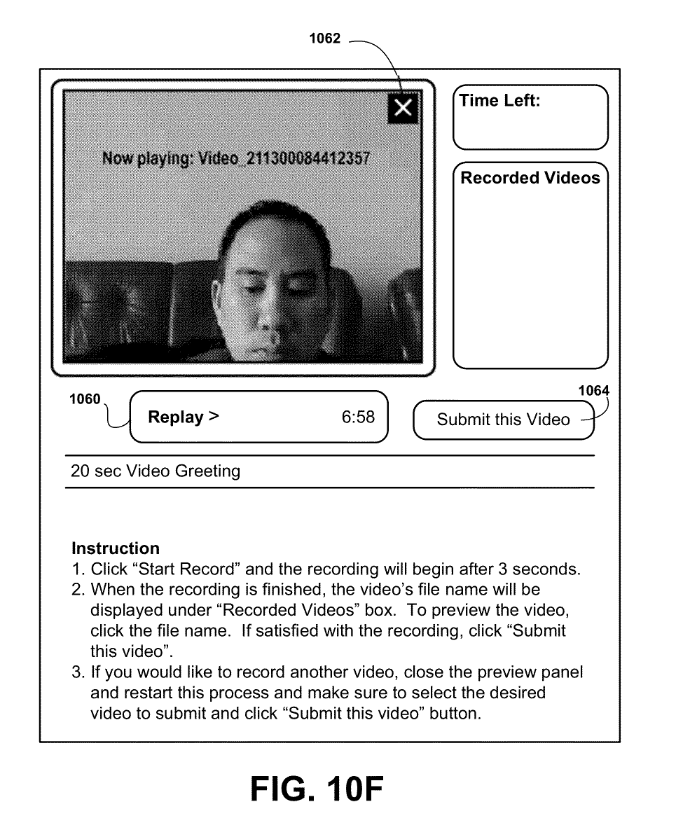

FIG. 10A is a flow chart showing the production of a Video Introduction in an exemplary embodiment. As described above, a job seeker may view a Job Report on a job seeker's device connected to the multimedia recruitment system via a network. The multimedia recruitment system may provide the Job Report along with an “Apply” button for the job seeker to apply for the job described in the Job Report (1000). When the job seeker presses the “Apply” button, the multimedia recruitment system may provide an additional button for the “Video Introduction” option (1002). When the job seeker selects the “Video Introduction” option, then the multimedia recruitment system may enable the job seeker to create a Video Introduction through the multimedia recruitment system. To create the Video Introduction, the job seeker may download an application from the multimedia recruitment system (1004).

FIG. 10B is a block diagram showing that a client side application 1022 is downloaded from the multimedia recruitment system 1024 and runs on the job seeker's device 1020. The multimedia recruitment system may be implemented in a server, such as a media server, and include a server side application 1026. The client side application may communicate with the server side application to establish a channel between the job seeker's device and the multimedia recruitment system for the transmission of video data in real time.

FIG. 10C shows the communication between the client side application 1030 and the server side application 1038 in an exemplary embodiment. The client side application initiates a connection to the multimedia recruitment system (1032). If the server side application is ready to receive images or streaming from the client side application, the server side application sends a message that the server is ready. The client side application receives a response from the sever side application and determines whether the connection is established for the transmission of video data (1034). If the connection fails, the application repeat the above process. If the connection is established, the application transmits the video data in real time as recording of the Video Introduction starts (1036).

In order to enable the job seeker to record a Video Introduction, the client side application may provide guidelines for recording the Video Introduction (1006 in FIG. 10A). FIGS. 10D-10F are exemplary user interfaces provided by the client side application in the job seeker's device. The initial user interface shown in FIG. 10D may include image window 1040, “Start Record” button 1042, text-based Instruction 1044, “Time Left” box 1046 and “Recorded Videos” box 1048. The image window displays the image captured by a camera in the job seeker's device. The text based Instruction may include information on the procedures for the job seeker to create a Video Introduction. For example, the guidelines may include information on the position of the job seeker's face on the image window. The “Time Left” box displays the time left to finish recording the Video Introduction. The “Recorded Videos” box may displays the file name of the Video Introduction recorded. The “Recorded Videos” box may display a plurality of file names when the job seeker records a plurality of Video Introductions.

If the job seeker pushes the “Start Record” button, recording of a Video Introduction may start. The client side application may receive a video stream from the camera and send the video stream or images to the multimedia recruitment system in real time. The multimedia recruitment system manages the video stream and images to create a Video Introduction file and save the Video Introduction file in the multimedia recruitment system or other file storage devices.

The client side application may receive video data for a predetermined time to create a Video Introduction (1008 in FIG. 10A). FIG. 10E shows an exemplary user interface provided when a Video Introduction is being recorded. The remaining time may be displayed in the “Time Left” box. When the Video Introduction is being created, a file name may be automatically assigned and displayed in the “Recorded Videos” box. A job seeker may stop recording the Video Introduction by pushing “Stop Record” button 1050. A job seeker may create a plurality of Video Introductions and select one of the plurality of Video Introductions for submission to an employer.

When a Video Introduction has been created, the job seeker may preview the Video Introduction before submission (1010 in FIG. 10A). FIG. 10F shows an exemplary user interface provided when a Video Introduction has been recorded. The user interface may provide “Replay” button 1060 to preview the Video Introduction. The job seeker can delete the recorded Video Introduction using “x” mark 1062 on the image window. The job seeker may repeat the above operations to create a plurality of Video Introductions until the job seeker is satisfied with one of the Video Introductions. The job seeker may submit a Video Introduction using “Submit” button 1064. The multimedia recruitment system may submit the Video Introduction to an employer (1012 in FIG. 10A).

When the job seeker approves the Video Introduction, the application may disconnect from the multimedia recruitment system.

FIG. 11 is an exemplary network environment 1100 suitable for implementing an exemplary embodiment. Environment 1100 may include a server 1150 coupled to job seeker's devices 1120, 1130 and 1170 and an employer's device 1140 via a communication network 1110. A multimedia recruitment system 1160 may be provided in server 1150. The employer may post information on job openings on a website in multimedia recruitment system 1160. Using the multimedia recruitment system, the employer is able to post the job opening information in a visual or video format. Job seeker's devices 1120, 1130 and 1170 may access server 1150 to search job openings posted in multimedia recruitment system 1160. Server 1150 and multimedia recruitment system 1160 may be managed by the employer or a third party recruiter. Communication network 1110 may include a television network, Internet, intranet, Local Area Network (LAN), Wide Area Network (WAN), Metropolitan Area Network (MAN), wireless communication network, etc.

FIG. 12 depicts exemplary computing device 1200 suitable for practicing an embodiment. Computing device 1202 may include execution unit 1204, memory 1208, keyboard 1210, pointing device 1212, network interface 1216 and storage 1218. Execution unit 1204 may include hardware or software based logic to execute instructions on behalf of computing device 1202. For example, in one implementation execution units 1204 may include one or more processors, such as a microprocessor. In one implementation, execution unit 1204 may include single or multiple cores 1205 for executing software stored in memory 1208, or other programs for controlling computing device 1202. In another implementation, execution unit 1204 may include hardware 1206, such as a digital signal processor (DSP), a graphics processing unit (GPU), a field programmable gate array (FPGA), an application specific integrated circuit (ASIC), etc., on which at least a part of applications can be executed. In another implementation, execution units 1204 may include virtual machine (VM) 1207 for executing the instructions loaded in the memory 1208. Multiple VMs 1207 may be resident on a single execution unit 1204.

Memory 1208 may include a computer system memory or random access memory (RAM), such as dynamic RAM (DRAM), static RAM (SRAM), extended data out RAM (EDO RAM), etc. Memory 1208 may include other types of memory as well, or combinations thereof. Computing device 1202 may include input devices, such as keyboard 1210 and pointing device 1212 (for example, a mouse) for receiving input from a user. A display device 1214, such as a computer monitor, may be provided. Optionally, keyboard 1210 and pointing device 1212 may be connected to display device 1214, or a soft keyboard may be implemented by a touchscreen input device. A graphical user interface (GUI) 1215 may be shown on the display device 1214. Computing device 1202 may include other suitable conventional I/O peripherals. Moreover, computing device 1202 may be any computer system such as a workstation, desktop computer, server, laptop, handheld computer, smartphone, or other form of computing or telecommunications device that is capable of communication and that has access to sufficient processor power and memory capacity to perform the operations described herein.

Additionally, computing device 1202 may include network interface 1216 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. Network interface 1216 may include a built-in network adapter, network interface card, personal computer memory card international association (PCMCIA) network card, card bus network adapter, wireless network adapter, universal serial bus (USB) network adapter, modem or any other device suitable for interfacing computing device 1202 to any type of network capable of communication and performing the operations described herein.

The storage device 1218 may be, for example, a hard-drive, CD-ROM or DVD, for storing an operating system (OS) and for storing application software programs, such as multimedia recruitment system 1220. Multimedia recruitment system 1220 may run on any operating system such as any of the versions of the Microsoft® Windows operating systems, the different releases of the Unix and Linux operating systems, any version of the MacOS® operating system for Macintosh computers, any embedded operating system, any real-time operating system, any open source operating system, any proprietary operating system, any operating systems for mobile computing devices, or any other operating system capable of running on the computing device and performing the operations described herein.

Furthermore, the operating system and multimedia recruitment system 1220 can be run from a bootable CD, such as, for example, KNOPPIX®, a bootable CD for GNU/Linux.

Multimedia recruitment system 1220 may enable an employer to produce a Job Report 1222 for a job opening. The job seekers may generate a Video Introduction 1224 using the multimedia recruitment system 1220. The generated Video Introduction 1224 may be submitted to the employer through the multimedia recruitment system 1220. With the above features, the multimedia recruitment system 1220 may enable the employer and the jobseekers to communicate with each other.

Exemplary embodiments are described above. It is, however, expressly noted that these exemplary embodiments are not limiting, but rather the intention is that additions and modifications to what is expressly described herein also are included within the scope of the present implementation. Moreover, it is to be understood that the features of the various embodiments described herein are not mutually exclusive and can exist in various combinations and permutations, even if such combinations or permutations are not made express herein, without departing from the spirit and scope of the present implementation.

Since certain changes may be made without departing from the scope of the present implementation, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present implementation and that the illustrations contained herein are singular examples of a multitude of possible depictions of the present implementation.

What is claimed is:

1. A recruitment system for generating a Job Report in a network environment, the recruitment system comprising:
a server coupled to a plurality of job seeker devices and at least an employer device via a communication network,
wherein an employer uploads using the employer device a text-based job description relating to a job opening to the server via the communication network link between the employer device and the server,
wherein the server includes a multimedia requirement system for the production of a Job Report produced by transforming the text-based job description using a platform into a script and a graphic form, by inputting the script into a teleprompter to be read by an on air talent and recorded using a camera as a first video, and by inputting the graphic form into a character generator for producing a second video, by storing the first and second videos in a storage area network, and editing the first and second videos to produce with both the first and second videos the Job Report, and
wherein the Job Report is viewed by at least a job seeker using one of the plurality of job seeker devices over the communication network from the server.

2. The recruitment system of claim 1, wherein the communication network is a network from a group consisting of the internet, a local area network, and a wide area network.

3. The recruitment system of claim 1, wherein the production of the Job Report includes the step of sending the script and the graphic form to the employer for review on the employer device via the communication network for approval.

4. The recruitment system of claim 1, wherein the graphic form is filled out by the employer on the employer device via the communication network.

5. The recruitment system of claim 1, wherein the employer uploads the text-based job description using a pre-populated form in a text editor format.

6. The recruitment system of claim 1, wherein the employer uploads the text-based job description using an online web form.

7. The recruitment system of claim 1, wherein the Job Report is uploaded by the employer from the server and wherein the Job Report is viewed on a employer website instead of the server.

8. The recruitment system of claim 1, wherein the Job Report further includes information selected from a group consisting of a film of an external actor, incrustation of a video, information from the news industry.

9. The recruitment system of claim 1, wherein the character generator creates a graphic overlay that comprises an employer name, an employer logo, and at least one graphic area.

10. The recruitment system of claim 9, wherein the at least one graphic area includes information selected from a group consisting of: a job name, a location of the job, a type of job, a level of experience needed for the job, and a description of responsibilities and duties.

11. The recruitment system of claim 10, wherein the Job Report is produced in a video format with an extension .MOV.

12. The recruitment system of claim 1, wherein the Job Report includes a contact information page at the end of the Job Report.

13. A method for producing a Job Report comprising the steps of:
uploading a text-based job description relating to a job opening in a multimedia requirement system using an employer device connected to a server hosting the multimedia requirement system, wherein the multimedia requirement system is in a computing device with an execution unit, a memory, and a network interface in communication with a storage;
transforming the text-based job description using a platform into a script and a graphic form;
inputting the script into a teleprompter to be read by an on air talent and recorded using a camera as a first video;
inputting the graphic form into a character generator for producing a second video;
storing the first and second videos in the storage; and
editing the first and second videos to produce a Job Report.

14. The method of claim 13, further comprising the step of having at least one of a plurality of job seekers uploading the Job Report on a job seeker device connected to the multimedia requirement system.

15. The method of claim 14, wherein the step of uploading the Job Report is a viewing using a video streamer from a web-based interface.

16. The method of claim 13, wherein the multimedia requirement system is on a communication network and the network is selected from a group consisting of the internet, a local area network, and a wide area network.

17. The method of claim 13, further comprising the step of sending the script and the graphic form for review.

18. The method of claim 13, wherein the step of uploading the text-based description includes the step of filling an online template.

19. The method of claim 18, wherein the step of filling the online template includes the step of uploading the text-based description in a pre-populated form.

20. The method of claim 13, wherein the step of editing the first and second videos to produce a Job Report includes the step of overlay of the first and second videos.

21. The method of claim 13, wherein the overlay comprises an employer name, an employer logo, and at least one graphic area.

22. The method of claim 13, wherein in addition to inputting the graphic form into the character generator, the second video includes information selected from a group consisting of a film of an external actor, incrustation of a video, information from the news industry.
